(19) United States
(12) Patent Application Publication
(10) Pub. No.: US 2025/0001221 A1
(43) Pub. Date: Jan. 2, 2025

(54) TOUCH-FREE SEAL CHECK SYSTEMS AND METHODS FOR RESPIRATORY PROTECTION DEVICES

(71) Applicant: 3M INNOVATIVE PROPERTIES COMPANY, St. Paul, MN (US)

(72) Inventors: Muhammad J. Afridi, Wooodbury, MN (US); Subhalakshmi M. Falknor, Woodbury, MN (US); Wei Zhao, Woodbury, MN (US); Ambuj Sharma, Woodbury, MN (US); Vahid Mirjalili, Ramsey, MN (US); Caroline M. Ylitalo, Stillwater, MN (US); Philip D. Eitzman, Lake Elmo, MN (US); Marie D. Manner, St. Paul, MN (US)

(21) Appl. No.: 18/578,748

(22) PCT Filed: Jul. 5, 2022
(86) PCT No.: PCT/IB2022/056221

§ 371 Date: Jan. 12, 2024

Related U.S. Application Data
(60) Provisional application No. 63/203,308, filed on Jul. 16, 2021.

(51) Int. Cl. A62B 27/00

(52) U.S. Cl. CPC A62B 27/00

(57) ABSTRACT

A fit detection system for a respiratory protection device is presented. The system includes a camera that captures an image sequence of a user wearing the respiratory protection device. The system also includes a feature extractor that analyzes the image sequence and extracts features from the image sequence. The system also includes a fit score calculator that analyzes the extracted features and calculates a fit score indicative of how well the respiratory protection device fits the user. The system also includes a communication component that communicates the fit score.

### BACKGROUND

As a commonly used protective article, a respiratory protection device is often used to protect against dust, mist, bacteria, etc., and is widely used in specific working environments and daily life. Respiratory protection devices and other face coverings are designed to provide a barrier to particulates and airborne or droplet-borne diseases, both by keeping exhalations from an infected individual contained and by providing a barrier from the coughs or exhalations of others. Respiratory protection devices (RPD) have been required PPE for healthcare and many industrial environments for years, and have seen increasing use as COVID-19 has required their usage in public places globally.

### SUMMARY

An objective of the present invention is to provide systems and methods for checking the quality of a seal of a respiratory protection device (RPD) worn by an individual in an environment. In-situ seal checks, without significant disruption to the individual, can more accurately detect insufficient sealing and provide feedback to the individual, which can better protect them from particulates, gas, microbes or other risks.

A fit detection system for a respiratory protection device is presented. The system includes a camera that captures an image sequence of a user wearing the respiratory protection device. The system also includes a feature extractor that analyzes the image sequence and extracts features from the image sequence. The system also includes a fit score calculator that analyzes the extracted features and calculates a fit score indicative of how well the respiratory protection device fits the user. The system also includes a communication component that communicates the fit score.

### BRIEF DESCRIPTION OF THE DRAWINGS

The embodiments of the present invention are described below merely as examples with reference to the accompanying drawings. In the accompanying drawings, the same features or components are represented by the same reference numerals, and the accompanying drawings are not necessarily drawn to scale. Further, in the accompanying drawings:

FIG. 1 is a view of a respirator.

FIGS. 2A and 2B illustrate respiratory protection devices (RPDs) worn by users in which embodiments of the present invention may be useful.

FIG. 3 illustrates a schematic of a system for checking an RPD seal on an individual in an environment in accordance with embodiments herein.

FIG. 4 illustrates a method of checking a fit of an RPD in accordance with embodiments herein.

FIG. 5 illustrates a schematic of a fit check system in accordance with embodiments herein.

FIG. 6 illustrates a mobile application for form fitting a respiratory protection device to a wearer in accordance with embodiments herein.

FIGS. 7A-7B illustrate an environment in which embodiments herein may be useful.

FIG. 8 illustrates a fit check system architecture.

FIGS. 9-11 illustrate example devices that can be used in embodiments herein.

FIGS. 12A-D illustrate images of individuals wearing RPDs as described in the Examples.

### DETAILED DESCRIPTION

The following descriptions are substantially merely exemplary, and are not intended to limit the present invention, the application, and the use. It should be understood that in all of the accompanying drawings, similar reference numerals represent the same or similar parts and features. The accompanying drawings illustratively show the idea and principles of the embodiments of the present invention, but do not necessarily show specific size of each embodiment of the present invention and the scale thereof. In some parts of specific accompanying drawings, related details or structures of the embodiments of the present invention may be illustrated in an exaggerated manner.

The use of personal protective equipment (PPE) has become an important part of the strategy to limit the spread of respiratory infections. Respiratory protection devices (RPDs) have become increasingly important globally as COVID-19 has spread. Two types of respiratory protection devices are in increasingly common use: filtering facepiece respirators (FFRs, referred to as “respirators” herein) and face masks (commonly called masks, often made of cloth). As used herein the term “respiratory protection devices” may refer to respirators, face masks, or other facial coverings.

The term “face mask” generally refers to a face covering that inhibits droplets from the wearer from spreading, e.g. from a cough or a sneeze. However, face masks often provide little or no protection against droplets from another individual. FFRs, in contrast, are designed to seal to a user's face, such that inhaled air is forced through one or more filter layers, such that most droplets, microbes, and particulates are removed from inhaled air before it reaches a wearer. Additionally, some FFRs include charged fibers that attract microbes or particulates, providing increased protection.

Filtering facepiece respirators (FFRs) are sometimes referred to as disposable respirators (DRs). When worn properly, FFRs are designed to protect the wearer by removing harmful particles from inhaled air. FFRs are regulated by the National Institute for Occupational Safety and Health (NIOSH). To provide the required level of protection, an FFR must seal to the wearers face, preventing gaps between the respirator and the wearer's skin since such gaps can allow contaminated air to leak into the breathing zone of the wearer. Therefore, tight fit of the FFR to the face of the wearer is essential.

Respiratory protection devices are mass produced with the goal of fitting many different facial structures, including male and female, high or low cheekbones, prominent jaws, etc. Additionally, respiratory protection devices are often worn during activity, such that the wearer may have different facial expressions during use, may walk or run, may smile or laugh. Additionally, different types and different models of respiratory protection device may be worn at different facial positions for the same user, depending on usage or activity.

Ideally, when worn, a respiratory protection device should fit the contour of the face of a wearer to form good sealing between the respirator and the face of the wearer. However, the contour of the face of the wearer is not the same between individuals, and there can be large differences from individual to individual. The contour of the nose is complex and fluctuates: it is often difficult to form a good seal, and a gap is often present between the respiratory protection device and the nose area of the wearer, resulting in a poor sealing effect. As a result, dust, mist or bacteria, virus, fungi in an environment where the wearer is located will be in contact with the wearer through the gap and is inhaled by the wearer, thus affecting the protective effect of the respirator. Additionally, the exhaled breath of the wearer will also be discharged upwards through this gap. For the case where the wearer wears glasses, if the temperature in the respirator is higher than the ambient temperature, the exhaled breath will cause fogging and affect the wearing experience of the wearer.

Therefore, in order to improve the protective effect of a respiratory protection device and improve the wearing experience, it is expected that the respiratory protection device can fit the contour of the face of the wearer and achieve good sealing between the respiratory protection device and the face of the wearer. In some RPDs, a metal or plastic nose strip with a memory effect is used to hold the RPD against a face of an individual. However, other sealing or seal-improving options may be used, including a shaped nose foam as described in, U.S. Provisional Patent Application with Ser. No. 63/201,604, filed on May 6, 2021.

The RPD should stay in place on an individual's face during any time the user is exposed to potentially harmful particulates or microbes. Many users of RPDs do not remain stationary during a workday, but move around, speak, walk, run, etc. For example, in an industrial setting a user may wear a respiratory protection device for one, two, four or even 8 hours while a clinician in a hospital may wear a respiratory protection device for an entire shift (8 hrs) or perhaps even a double shift (16 hrs). It is conceivable, potentially even likely, that an RPD may move during this time, potentially causing a good seal to become a bad seal. The ability to detect in real time when an individual's RPD no longer adequately seals to their face, and is no longer providing sufficient protection, increases safety in a workplace. It is important that systems and methods for checking the quality of a respirator seal be simple to use or interact with, provide quick feedback, and be touch-free, so that an individual does not lose significant amounts of time during a shift. Additionally, it is desired that systems and methods not rely on a component built into the RPD, as it is desired to keep costs of individual RPDs low.

Described herein are systems and methods that may be useful for environments in which users wear respiratory protection devices generally. Systems and methods herein may be useful for in-situ seal checks for individuals wearing RPDs.

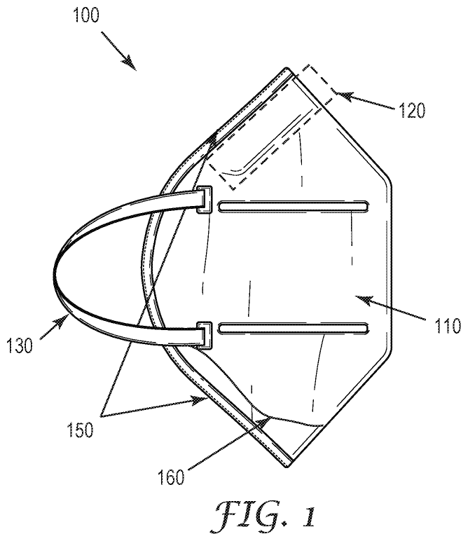

FIG. 1 is a view of a respirator. Respirator 100 is an earloop respirator. In the example shown in the drawing, respirator 100 is a foldable earloop respirator. However, the present invention is not limited thereto, and may also be applied to non-foldable or non-earloop respirators as well as to other RPDs more broadly. In the manufacturing process of the first respirator 100, a formable nose piece (often metal, however other suitable materials are envisioned) is attached to an inner or outer side of a respirator main body 110, within area 120. When the first respirator 100 is worn, a lanyard 130 is hung on the left and right ears of the wearer, respectively.

It is intended that a user adjust respirator 100 so that the nose of the wearer is accommodated by adjusting the formable nose piece such that area 120, and the exterior edge 150 conform to the contour of the face of the wearer to closely fit the periphery of the nose of the wearer, thus reducing or even eliminating the gap between the respirator and the nose of the wearer. A good seal between respirator 100 and the face of the wearer is important for safety concerns.

Earloops 130, or another tension device such as a headband, pull RPD 100 toward the face of a user, causing a seal to form on a face contacting portion of the RPD. A seal may not necessarily form along edges 150. For example, a seal may form along line 160, where a user's chin seals the RPD along a jawline.

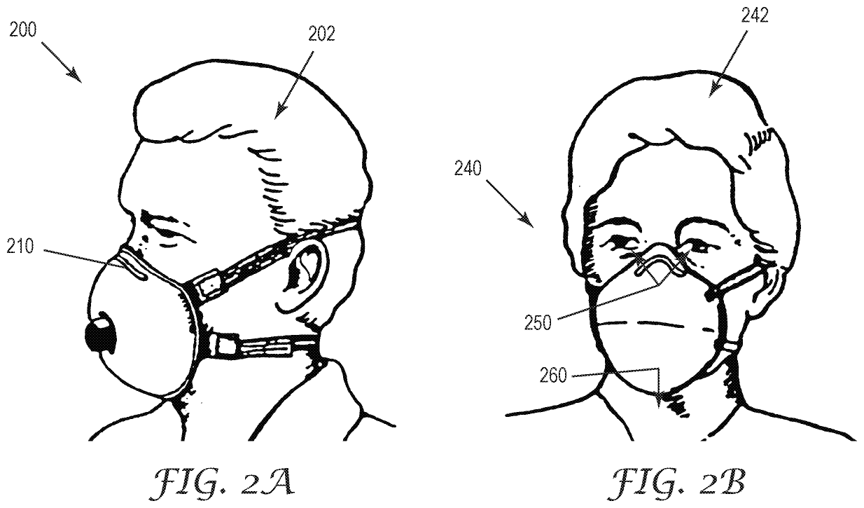

FIGS. 2A and 2B illustrate a respiratory protection device worn by a user in which embodiments of the present invention may be useful. As illustrated in FIGS. 2A and 2B, respiratory protection devices 200 and 240 can be secured over a user's face using a variety of methods other than the lanyard illustrated in FIG. 1.

Respiratory protection devices 200 and 240 are intended to form a seal along the edges of the RPD, where the face-contacting side contacts the face. If an imperfect seal is present, then exhaled air may be forced upward, out of the nose portion as indicated by arrows 250, and/or downward, out through the chin portion, as indicated by arrow 260, causing discomfort for some users, and may also cause respiratory protection devices 200, 240 to move up or down along a nose of user 202. A user can adjust a nose clip 210 to improve the fit of respiratory protection devices 200, 240. It may also be necessary, if a particular RPD 200, 240 does not fit well, to move up or down in size, or to switch to a different model of RPD.

It is desired to have a system or method that can check the seal of an RPD 200, 240 while users 202, 242 are in a working environment. For example, users 202, 242 may be doctors, nurses or other healthcare workers in a hospital where they may be exposed to dangerous microbes. Or users 202, 242 may be workers in an industrial setting where they may be exposed to particulates or gases.

It is important that users 202, 242 have a good seal present at all times when in a work environment where an RPD is required. Seal check sensors have been added to RPDs in the past to allow a user to obtain an instantaneous check of an RPD seal. However, this requires a user 202, 242 to have purchased an RPD with such a sensor, which will have an increased cost compared to an RPD without a sensor. Additionally, at least some sensors require the user to activate, or touch to initiate a seal check. This is not desirable as it requires a user to interrupt their activity and touch their mask (which may be particularly undesirable in a healthcare setting), which may also cause the mask position to change.

Additionally, sensors are currently not available for filtering facepiece respirators, but only for elastomeric or rubber face pieces. It is desired to be able to monitor a variety of RPDs.

In industries where tight-fitting facepieces, such as RPDs are required, fit testing is the responsibility of the employer, and may be done annually or more frequently. Fit testing is done to ensure that an individual has an RPD that provides a good seal with a tight-fitting mask. Because face structures can vary widely between individuals, fit testing should happen during the initial selection of an RPD, before it is worn in a hazardous environment.

Users are responsible for conducting fit checks every time an RPD is used. A user must understand how to conduct a fit check each time an RPD is put on, and be trained in the technique for fit checking each model of RPD they use. Negative and positive pressure techniques may be used to judge the quality of the fit. However, individuals are not perfect and it is possible for a user to forget to fit check an RPD, forget how to fit check an RPD, or conduct the fit check incorrectly. Even when done correctly, judging the quality of a fit does not necessarily result in a numeric value that clearly provides an indication that a fit is good or poor.

It is desired to have a system or method for conducting fit checks that takes some of the responsibility or guesswork out of the hands of the users. A system or method that can provide a quantitative fit value, that can be compared to a threshold of acceptable fit, provides reassurance to both a user and an employer. Such systems and methods are envisioned in embodiments herein.

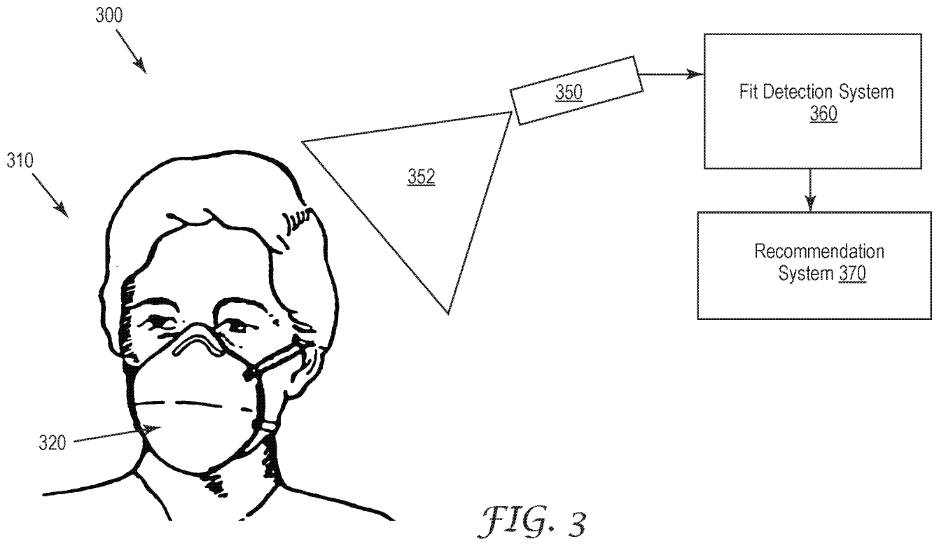

FIG. 3 illustrates a schematic of a system for checking an RPD seal on an individual in an environment in accordance with embodiments herein. A fit detection system 360 is located in an environment 300. A user 310 is in environment 300 and is wearing an RPD. Environment 300 may be a healthcare environment, an industrial environment, or any other environment where RPDs 320 are required PPE for individuals 310.

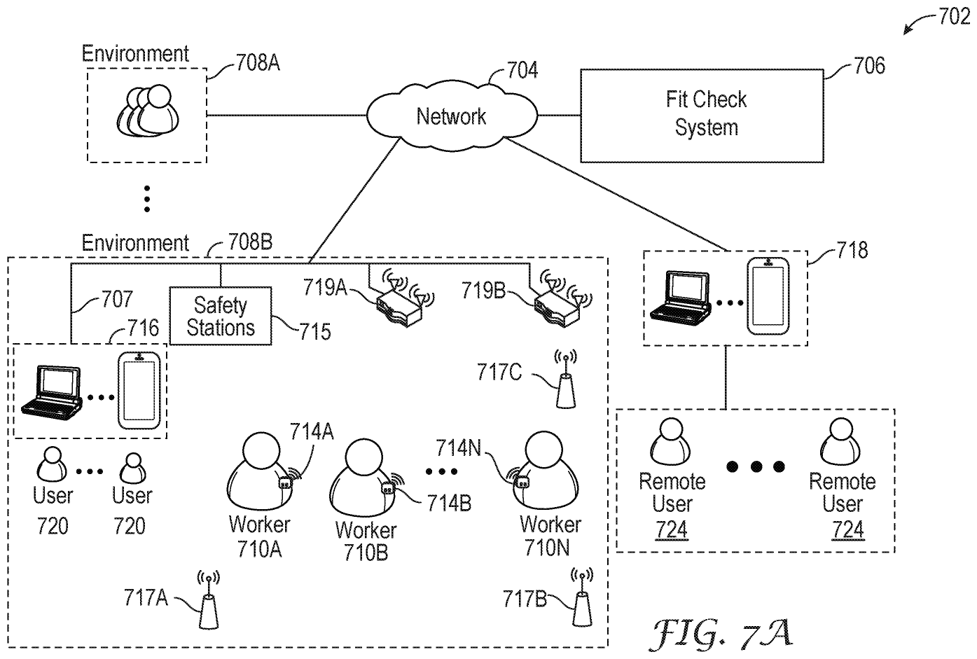

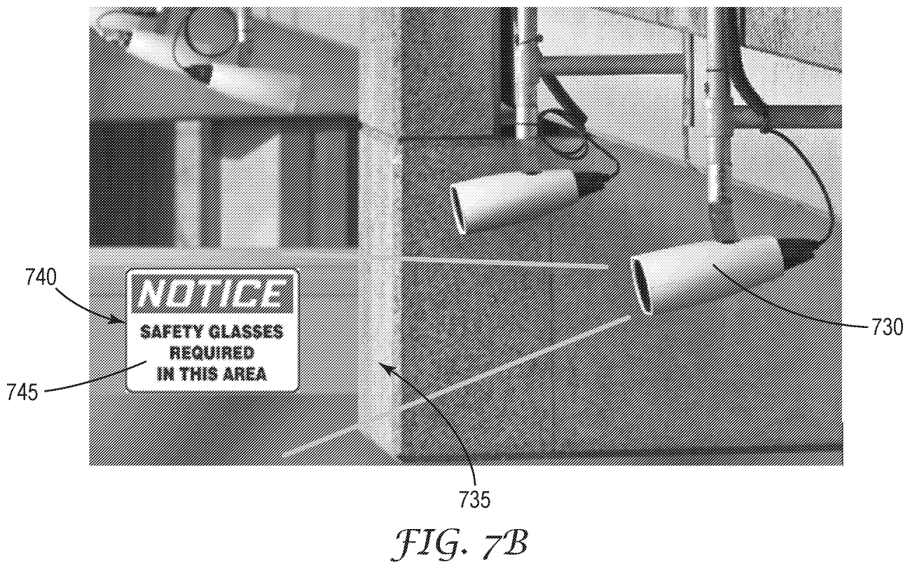

As discussed in greater detail with respect to FIGS. 7A-7B, an environment 300 may include one or more cameras 350, each with a field of view 352. In some embodiments, camera 350 may be a mounted camera, for example a security camera mounted in a corner or on a wall. In some embodiments, camera 350 may be a semi-mobile camera, for example in a fixed position with a pan and tilt assembly. In some embodiments, camera 350 is a mobile camera, for example mounted on another user or mounted on a mobile robot capable of moving about environment 300. It is also expressly envisioned that environment 300 may have multiple cameras. However, for ease of understanding, only one camera 350 is illustrated in FIG. 3.

Camera 350 has a field of view 352 that captures an image, series of images, or video of user 310 when user 310 enters field of view 352. Fit detection system 360 receives images of user 310 and, based on the images, determines whether or not a fit is satisfactory. For example, a filtering facepiece respirator moves when a user breathes in and out. The movement pattern is different if the fit is good, and air is forced in and out of the fabric layers, then if the fit is poor, and air leaks out around the nose or chin portion. That difference in movement is detectable by analyzing images of user 310 wearing mask 320. Fit detection system 360, as discussed in greater detail herein, may analyze color changes of one or more pixels corresponding to RPD 320 features.

Fit detection system 360 may output a numerical evaluation of fit for RPD 320 to a recommendation system 370. Based on the numerical output, recommendation system 370 may indicate to individual 310 that RPD 320 is adequately sealed, or not adequately sealed. If RPD 320 is not adequately sealed, then system 370 may provide recommendations to increase the safety of individual 310, for example by repositioning RPD 320, adjusting a nosepiece of RPD 320, or by recommending a user change out RPD 320 for a different size or model.

Camera 350 may be any suitable optical sensor, including a thermal camera, a hyperspectral range camera, an IR camera, a visible-light camera, a time-of-flight sensor, or another suitable camera. Camera 350 may capture a video stream, or capture images periodically. Camera 350 may only capture images, or send captured images to fit detection system 360, based on detection of individual 310 in field of view 352.

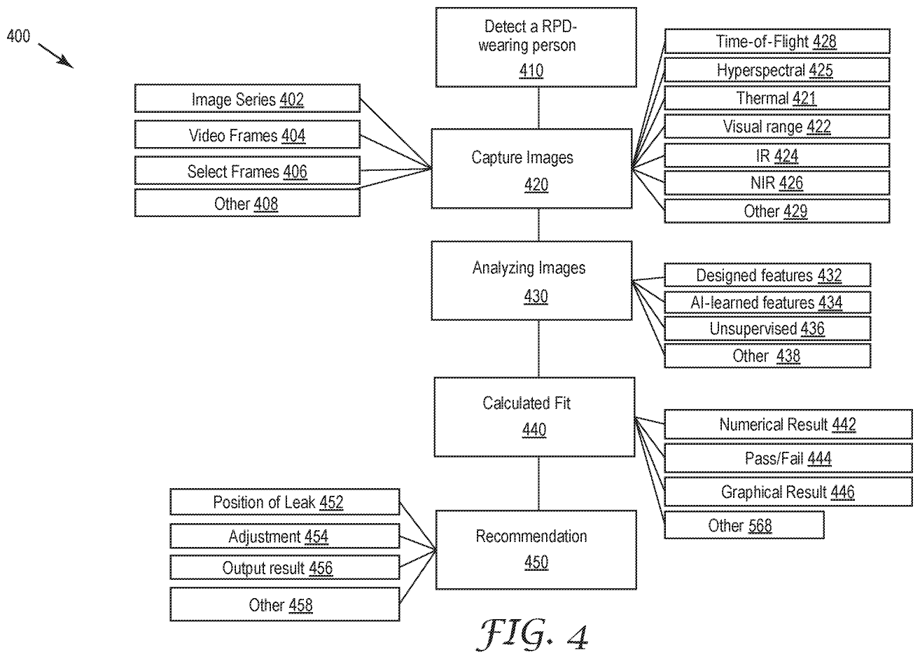

FIG. 4 illustrates a method of checking a fit of an RPD in accordance with embodiments herein. Method 400 may be implemented in an environment where individuals require RPD protection. The environment may have one or more mounted, stationary, mobile or roving camera systems.

In block 410, a person wearing an RPD is detected. Detecting a person in a field of view of a camera can be done using any known or future developed techniques. Detecting a person may involve detecting movement within a field of vision of a camera and identifying it as a human. Detecting a person may also include identifying the person, for example as a nurse vs a doctor, or as a particular individual, such as Nurse John Doe. In some embodiments, different PPE requirements may be necessary based on the identity of the identified person. For example, a nurse may require a respirator while a surgical mask may be sufficient for a doctor.

In block 420, images of the individual are captured. A number of images may be captured, to ensure that sufficient data is available to analyze. The images may be captured by an optical sensor, such as a camera. The camera may be a thermal camera 421, a visual light spectrum camera 422, an IR-spectrum camera 424, an NIR-spectrum camera 426, a hyperspectral-range camera 425, or a time-of-flight sensor 428 or other image capture device 429. The captured images may be a series of images captured by a camera, as indicated in block 402, or sequential frames of a video captured by a camera, as indicated in block 404. The camera may only pass on a subset of images captured, as indicated in block 406. For example, a video captured may have a high enough frame rate such that sequential frames are too close together to capture data about a user inhaling or exhaling. In embodiments where analysis is done remote from the camera, sending only a subset of frames may allow for faster data transmission and analysis. Other image selections, as indicated in block 408, are also expressly contemplated.

In block 430, images of the individual are analyzed. For example, an algorithmic analyzer may be taught to look for pixel color changes indicative of a user inhaling, and drawing the mask toward their face, or exhaling, and pushing the mask away from their face. The analyzer may operate based on designed features, as indicated in block 432. The designed features may be selected to capture motion and color change in key areas of an RPD, for example the areas of the mask that expand and contract based on a user inhaling and exhaling. Alternatively, the features may be selected to capture motion and color change in areas of the mask indicative of a leak. These selected design features may be provided to a neural network, or to any other supervised learning approach or regression approaches discussed herein. For example, dense motion trajectories, optical flow, 3D ConvNet features, multi-stream 3D convnets or other methods may be used.

In block 434, instead of using designed features, learned features are used by an artificial intelligence. For example, the inhale/exhale motion may be described to an algorithm, which will then learn features to track to determine fit. For example, deep learning based end-to-end approaches will determine important features and how to assign fit scores. Instead of a supervised approach, it is also envisioned that, in some embodiments, an unsupervised approach may be used, as illustrated in block 436. Other approaches are also envisioned, as indicated in block 438.

Supervised models, as used herein, are models given input data (for example 2300 images of people wearing respirators) with labels (for example 1100 of the images are labelled “good fit” while 1200 of the images are labeled “poor fit”). Based on the input data and labels, a machine learning algorithm uses various features to relate the photos to the labels.

In contrast, as described herein, unsupervised models are just given input data (e.g. just the 2300 images of people wearing respirators). Based on the images, the machine learning algorithm attempts to identify patterns. The machine learning algorithm may return, for example, 3 clusters of images, where each cluster's images are similar in some fashion-for example, it may have clustered Good Fits, Poor Fits, and Unknown Fits. It may also have clustered the images differently, which may provide new information, such as that most poor fits are worn much higher or much lower on the nose than most good fits, or the clustering may have been based on the amount of nose or cheekbone seen around the respiratory protection device.

Extracting a feature for analysis may include analyzing a pixel or a group of pixels as it changes in images taken over time. A pixel can contain a lot of information. The pixel's movement, color change, and speed can all be tracked. Computer vision features in general can include lines, textures, blobs, shapes, color, motion, background vs foreground, etc. Additionally, some algorithms may analyze more abstract notions like shadows or lighting changes, size change of objects, etc. A number of well-known techniques could be applied, for example, Dense motion trajectories, optical flow, 3D ConvNet features, multi-stream 3D convnets etc.

In block 440, once the images are analyzed and features extracted for analysis, a fit is calculated. The fit may be calculated as a numerical result, as indicated in block 442. The fit may be calculated by comparing to a pass or fail threshold, as indicated in block 444. A graphical result may be calculated, as indicated in block 446, for example showing how a fit score changes over time for a user. Other quantitative fit calculation metrics may also be used as indicated in block 468.

While method 400 illustrates embodiments where a fit score is computed, it is expressly contemplated that, in some embodiments, the fit analyzer may, using approaches like SVM, C4.5 decision trees, neural networks, k-NN or another suitable approach, directly predict a fit pass or fail.

In block 450, a recommendation is provided based on the fit. The recommendation may be the calculated fit output to a source, as indicated in block 456, such as a display, a communications unit (such as a speaker), or a remote source. In some embodiments, a recommendation goes further than providing the calculated fit, and may also indicate where a leak is on the respirator seal, as indicated in block 452. In some embodiments, the recommendation may also include a recommended adjustment, as indicated in block 454, such as repositioning a nose clip. The recommendation may also include other information, such as indicating a consistent lack of fit, determined by a system that has access to historically calculated fit data, or recommend retraining on self-seal checking or a new RPD model or size as indicated in block 458.

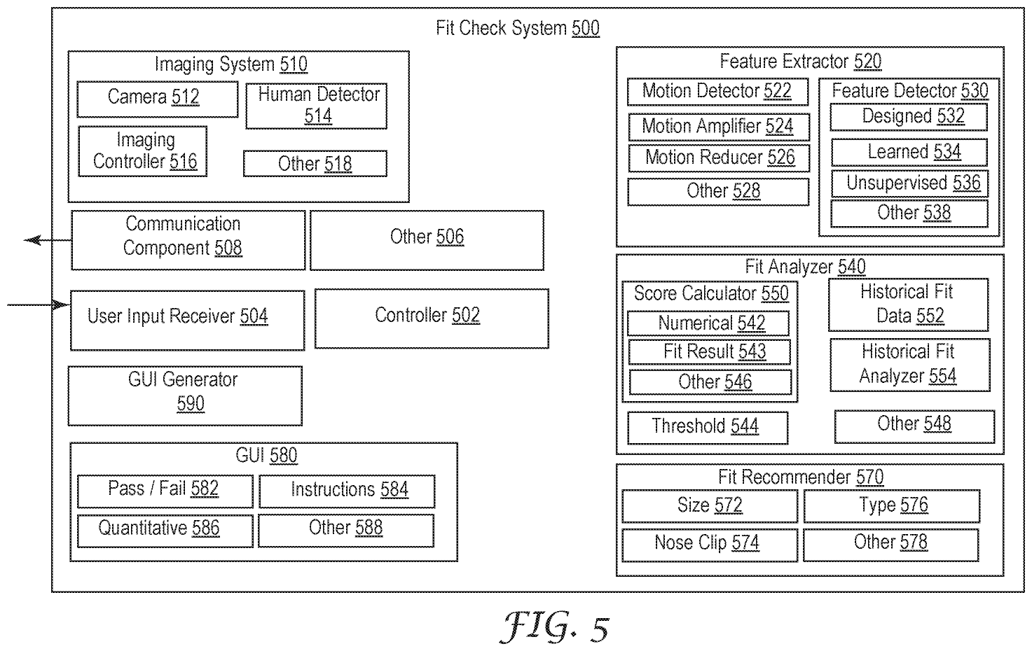

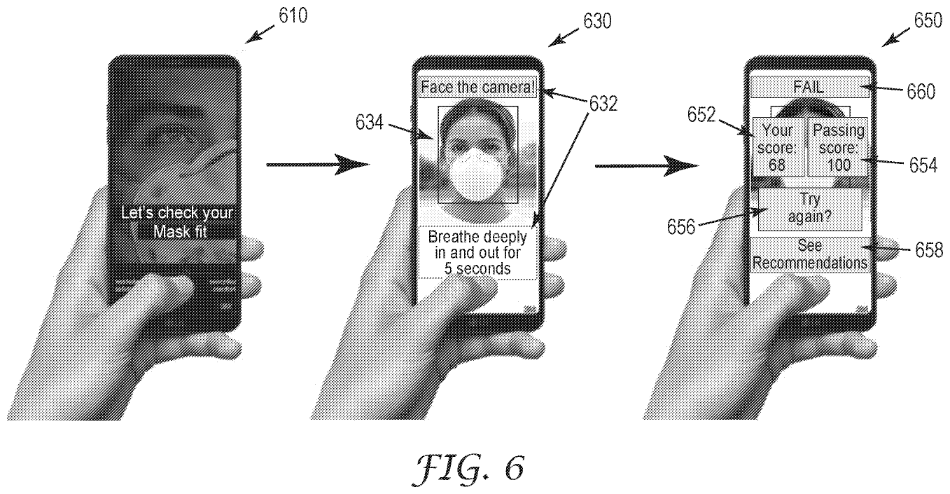

FIG. 5 illustrates a schematic of a fit check system in accordance with embodiments herein. Fit check system 500 may be built into an environment, for example with camera 512 mounted to a wall, corner or on a mobile unit within the environment. Fit check system 500 may also be part of a distributed system, for example with some portions located physically within an environment, and other portions accessible over a wireless or cloud-based network.

Fit check system 500 includes an imaging system 510. Imaging system includes a camera 512. In some embodiments, camera 512 is a camera system, with a light source, pan/tilt system, or movement mechanism. For example, camera 512 may be mounted on a wall, associated with an access point, a mobile system such as cellular phone, tablet, or heads-up-display unit, or mounted on a mobile robot that roams an environment either on a preset or randomized pattern. Camera 512 may be a time-of-flight camera, a hyperspectral camera, a thermal camera, a visual range camera, an IR camera, an NIR camera or another suitable optical sensor. Imaging system may also include a human detector 514. In some embodiments, camera 512 may only capture or record images when a human is detected within a field of view. Such activity may be controlled by imaging controller 516, which may control movement of a robot system, or a pan/tilt system, or may activate or deactivate a light system, for example. Imaging system 510 may have other features 518 as well.

Feature extractor 520 extracts features from images captured by imaging system 510. Feature extractor 520 may receive each image captured by imaging system 510, a video stream captured by imaging system 510, or a subset of data captured by imaging system 510. For example, a camera may capture images at a high enough rate, or a video camera may have a high frame rate, such that sequential images do not have sufficient contrast for feature detection/extraction. It may be more useful to compare images selected across a timeframe of an individual inhaling and exhaling. It may be desired to reduce a number of images processed by a feature extractor 520 to a number sufficient for feature extraction while being conscious of data transfer and analysis speed.

Feature extractor may focus in on important sections or movements within an image sequence. For example, a motion detector 522 may detect features of interest, such as an area of an RPD that exhibits changes in pixel color across sequential frames. A motion amplifier 524 may amplify motion of interest, such as the motion of the area of the image portraying the RPD, while a motion reducer 526 may reduce motion that is not of interest, such as the rest of the individual wearing the RPD. Using motion amplifier 524 and reducer 526, fit check system 500 may be able to capture images of an individual moving toward imaging system 510, which may reduce the time it takes to provide a fit recommendation. In some embodiments, feature extractor 520 has a feature detector 530 responsible for detecting features indicative of a fit quality within provided image data. The feature extraction may be supervised, searching for design features 532 or learned features 534. Alternatively, the feature extraction may be an unsupervised feature extraction 536. Other feature detection mechanisms 538 are expressly contemplated. Feature extractor 520 may have other functionality 528 as well.

Fit analyzer 540 includes a score calculator 550 that, based on analysis of extracted features, calculates a fit score. The score may be calculated as a numerical value, as indicated in block 542. The score may be provided through an unsupervised analysis as a fit result 54. In embodiments where a numerical result 542 is calculated, it may be compared to a threshold 544. Fit scores above threshold 544 may indicate a sufficient score, and fit scores below threshold 544 may indicate an insufficient score. In some embodiments, fit analyzer 540 may have access to historical fit data 552, such as data previously captured by fit check system 500 for a specific individual at other times. In some embodiments, fit check system 500 repeats a fit check until a passing score is obtained, or until it is determined, based on previous results 552, that a passing fit score is unlikely and retraining or fit guidance is needed. Based on historical fit data 552, a historic fit analyzer 554 may provide guidance to fit recommender 570. Fit analyzer 540 may provide other functionality 548.

Fit recommender 570 may prepare recommendations for improving the fit score for an individual. In some embodiments, fit recommender 570 is only activated if a failing fit score is obtained. A size recommendation 572, for example to decrease a size for a leaky mask, may be provided. A new mask type 576, such as a different make or model of RPD may be provided, for example based on a facial profile of the user, as some RPDs may fit some individuals better than others. Additionally, instructions may be provided on adjusting a nose clip 574 to provide a better fit. Other recommendations 578 may also be provided.

In some embodiments, for example as described in greater detail in FIG. 6, fit check system 500 is built into a device with a display component, and a graphical user interface generator 590 that, based on information from fit analyzer 540 and fit recommender 570, generates a graphical user interface 580. GUI 580 may include an indication 582 of whether the user passed or failed a fit check. GUI 580 may include a quantitative result 586 indicative of the numerical fit score, which may be provided with the threshold 544. Instructions 584 may be presented for improving a fit score. GUI 580 may also include other information 588 or images, such as a projection of images as captured by camera 512.

User input receiver 504 may receive input from a user. In embodiments where fit check system 500 is built into a device, such as a mobile computer, kiosk, mobile phone, tablet, etc., user input receiver 504 may include a keyboard. In some embodiments, user input receiver 504 includes a microphone that can pick up audio commands from a user.

Communication component 508 may communicate with a source remote from fit check system 500, for example over a wired, wireless, or cloud-based network. For example, while historical fit data 552 is illustrated as part of fit check system 500, it is expressly contemplated that such data may be stored remote from fit check system 500. Similarly, information relevant to identifying a particular human, using human detector 514, such as facial recognition information, may also be stored remote from fit check system 500.

Controller 502 may control activity of components of fit check system 500, for example activating feature extractor 520, fit analyzer 540, fit recommender 570 or communication component 508. Controller 502 may also cause GUI generator 590 to update a GUI 580 based on updated images from camera 512, or based on updated fit result 544, or recommendations from fit recommender 570.

Fit check system may include other components 506 not described in detail with respect to FIG. 5.

FIG. 6 illustrates a mobile application for form fitting a respiratory protection device to a wearer in accordance with embodiments herein. FIG. 6 illustrates a progression of example graphical user interfaces 610, 630, 650 that a user may encounter while conducting a fit check. An application such as that illustrated in FIG. 6 may be intended for general public use, for example for individuals wanting to wear an RPD to limit spread of an illness or to prevent themselves from getting sick. However, the graphical user interfaces represented in FIG. 6 may also be presented on a display associated with a kiosk or otherwise associated with a work environment, such as environment 700, discussed below with respect to FIG. 7A.

Graphical user interface 610 illustrates an opening screen of an application that a user has opened.

Graphical user interface 630 illustrates a user receiving instructions for capturing image data of the user wearing an RPD. Instructions 632 are presented as both above and below an image 634. Image 634 may be a stock photo showing how the user should view the screen (e.g. facing forward), or may be a live view of what a front-facing camera of a mobile computing device is currently recording.

Graphical user interface 650 illustrates results presented to the user after a fit test has been conducted. The fit test results may be presented as a pass/fail indication 660. A fit score 652 may be presented. A required score to pass 654 may be presented. An option to retry the fit test 656 may be presented. For example, a user may want to retake the test after seeing and implementing recommendations 658.

The fit test score and recommendations may be generated locally, using a CPU of the mobile computing device, in one embodiment. In another embodiment, the images captured of the user are wirelessly transferred to a remote server that houses the fit score and recommendation algorithms.

FIGS. 7A-7B illustrate an environment in which embodiments herein may be useful.

An environment 700 may represent any number of environments in which workers may need to wear RPDs, such as healthcare settings, industrial settings, or any office setting during a pandemic or flu season. Environment 700 includes a fit check system 706 for detecting RPD-wearing individuals and checking the fit of their RPD.

Fit check system 706 may reduce incidents of intentional or unintentional RPD misuse by workers in worksite 702. Fit check system 706 may also allow safety professionals to more easily manage health and safety compliance training, and determine which individuals need to change RPD size or models, or who needs retraining on donning RPDs correctly.

In general, fit check system 706, as described in greater detail herein, is configured to identify RPD-wearing individuals within a worksite, conduct fit checks of those individuals and provide fit check results and recommendations to improve fit, when needed. System 706 may be connected, through network 704, to one or more devices or displays 716 within an environment, or devices or displays 718, remote from an environment. System 706 may provide alerts to workers 710A-710N when a fit check comes back as failing, as well as provide feedback on how to improve fit.

System 706 may also be integrated into entry protocols for secured areas within an environment such that workers that do not pass a fit check are restricted out of a secure or dangerous area.

As shown in the example of FIG. 7A, system 702 represents a computing environment in which a computing device within of a plurality of physical environments 708A, 708B (collectively, environments 708) electronically communicate with fit check system 706 via one or more computer networks 704. Each of physical environments 708A and 708B represents a physical environment, such as a work environment, in which one or more individuals, such as workers 710, utilize respiratory protection devices while engaging in tasks or activities within the respective environment.

In this example, environment 708A is shown as generally as having workers 710, while environment 708B is shown in expanded form to provide a more detailed example. In the example of FIG. 7A, a plurality of workers 710A-710N may be wearing a variety of different PPE, including an RPD.

In some examples, each of environments 708 include computing facilities, such as displays 716, by which workers 710 can communicate with fit check system 706. For example, environments 708 may be configured with wireless technology, such as 802.11 wireless networks, 802.15 ZigBee networks, and the like. In the example of FIG. 7A, environment 708B includes a local network 707 that provides a packet-based transport medium for communicating with fit check system 706 via network 704. In addition, environment 708B may include a plurality of wireless access points 719A, 719B that may be geographically distributed throughout the environment to provide support for wireless communications throughout the work environment.

As shown in the example of FIG. 7A, an environment, such as environment 708B, may also include one or more wireless-enabled beacons, such as beacons 717A-717C, that provide accurate location information within the work environment. For example, beacons 717A-717C may be GPS-enabled such that a controller within the respective beacon may be able to precisely determine the position of the respective beacon. Alternatively, beacons 717A-717C may include a pre-programmed identifier that is associated in fit check system 706 with a particular location. Based on wireless communications with one or more of beacons 717, or data hub 714 worn by a worker 710, fit check system 706 is configured to determine the location of the worker within work environment 708B. In this way, event data reported to fit check system 706 may be stamped with positional information.

In example implementations, an environment, such as environment 708B, may also include one or more safety stations 715 distributed throughout the environment to provide fit testing by accessing fit testing system 706. Safety stations 715 may allow one of workers 710 to conduct a fit check by positioning themselves in front of a camera and following instructions provided either audibly, visually or otherwise by safety station 715.

In addition, each of environments 708 include computing facilities that provide an operating environment for end-user computing devices 716 for interacting with fit check system 706 via network 704. For example, each of environments 708 typically includes one or more safety managers or supervisors, represented by users 720 or remote users 724, are responsible for overseeing safety compliance within the environment. In general, each user 720 or 724 interacts with computing devices 716, 718 to access fit check system 706. For example, the end-user computing devices 716, 718 may be laptops, desktop computers, mobile devices such as tablets or so-called smart cellular phones.

Fit check system 706 may be configured to actively monitor workers 10A-10N and other users 720 within an environment 708 both for correct usage of RPDs. Referring to FIG. 7B, a worksite may have one or more cameras 730, either fixed within the worksite, mobile (e.g. drone, robot or equipment-mounted) or associated with a worker 710A-710N (e.g. an augmented reality headset or other camera worn in association with PPE, etc.). Using the one or more cameras, fit check system 706 may be able to automatically identify whether or not a worker 710A-710N passes or fails a fit check, without the worker 710A-710N being interrupted during a task.

As another example, fit check system 706 may further trigger an alert if a fit check is failed, either once or repeatedly by a given worker. The alert may be sent to worker 710, either through a communication feature of a PPE, a separate communication device, or through a public address system within the environment. A failed fit check alert may also be sent to a supervisor or safety officer associated with the environment 708 as well. Fit check results items may also be tracked and stored within a database, as described herein.

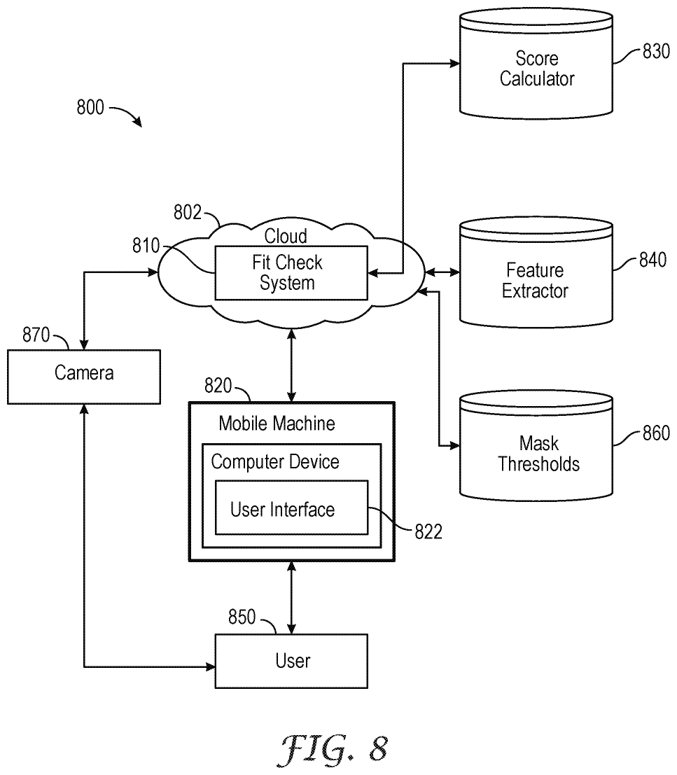

FIG. 8 is a block diagram of a fit check system architecture. The remote server architecture 800 illustrates one embodiment of an implementation of fit check system 810. As an example, remote server architecture 800 can provide computation, software, data access, and storage services that do not require end-user knowledge of the physical location or configuration of the system that delivers the services. In various embodiments, remote servers can deliver the services over a wide area network, such as the internet, using appropriate protocols. For instance, remote servers can deliver applications over a wide area network and they can be accessed through a web browser or any other computing component. Software or components shown or described in FIGS. 1-7 as well as the corresponding data, can be stored on servers at a remote location. The computing resources in a remote server environment can be consolidated at a remote data center location or they can be dispersed. Remote server infrastructures can deliver services through shared data centers, even though they appear as a single point of access for the user. Thus, the components and functions described herein can be provided from a remote server at a remote location using a remote server architecture. Alternatively, they can be provided by a conventional server, installed on client devices directly, or in other ways.

In the example shown in FIG. 8, some items are similar to those shown in earlier figures. FIG. 8 specifically shows that a fit check system 810 can be located at a remote server location 802. Therefore, computing device 820 accesses those systems through remote server location 802. User 850 can use computing device 820 to access user interfaces 822 as well. For example, a user 850 may be a user wanting to check a fit of their respiratory protection device while sitting in a parking lot, and interacting with an application on the user interface 822 of their smartphone 820, or laptop 820, or other computing device 820.

FIG. 8 shows that it is also contemplated that some elements of systems described herein are disposed at remote server location 802 while others are not. By way of example, algorithm and data storage 830, 840 or 860, as well as a camera 870 can be disposed at a location separate from location 802 and accessed through the remote server at location 802. Regardless of where they are located, they can be accessed directly by computing device 820, through a network (either a wide area network or a local area network), hosted at a remote site by a service, provided as a service, or accessed by a connection service that resides in a remote location. Also, the data can be stored in substantially any location and intermittently accessed by, or forwarded to, interested parties. For instance, physical carriers can be used instead of, or in addition to, electromagnetic wave carriers. This may allow a user 850 to interact with system 810 through their computing device 820, to initiate a fit check process.

It will also be noted that the elements of systems described herein, or portions of them, can be disposed on a wide variety of different devices. Some of those devices include servers, desktop computers, laptop computers, imbedded computer, industrial controllers, tablet computers, or other mobile devices, such as palm top computers, cell phones, smart phones, multimedia players, personal digital assistants, etc.

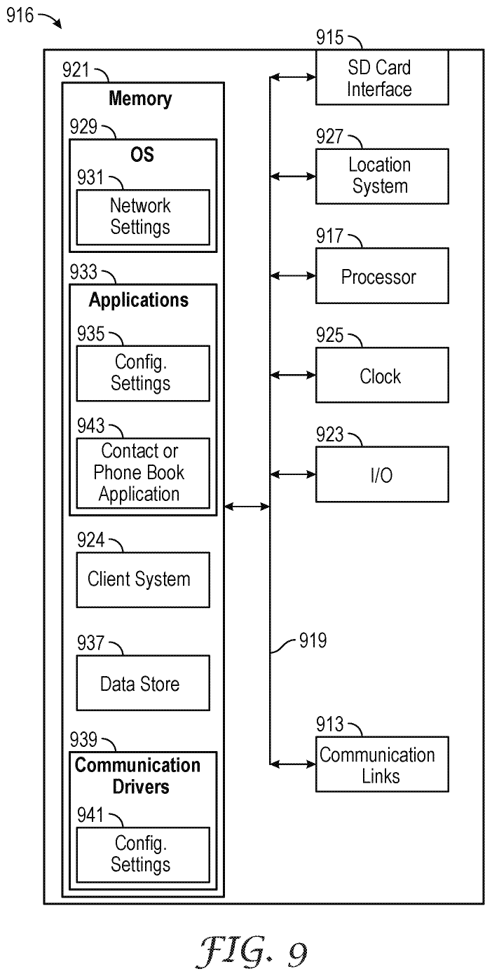

FIGS. 9-11 illustrate example devices that can be used in the embodiments shown in previous Figures. FIG. 9 illustrates an example mobile device that can be used in the embodiments shown in previous Figures. FIG. 9 is a simplified block diagram of one illustrative example of a handheld or mobile computing device that can be used as either a user's device or a supervisor/safety officer device, for example, in which the present system (or parts of it) can be deployed. For instance, a mobile device can be deployed in the operator compartment of computing device for use in generating, processing, or displaying the data.

FIG. 9 provides a general block diagram of the components of a mobile cellular device 916 that can run some components shown and described herein. Mobile cellular device 916 interacts with them or runs some and interacts with some. In the device 916, a communications link 913 is provided that allows the handheld device to communicate with other computing devices and under some embodiments provides a channel for receiving information automatically, such as by scanning. Examples of communications link 913 include allowing communication though one or more communication protocols, such as wireless services used to provide cellular access to a network, as well as protocols that provide local wireless connections to networks.

In other examples, applications can be received on a removable Secure Digital (SD) card that is connected to an interface 915. Interface 915 and communication links 913 communicate with a processor 917 (which can also embody a processor) along a bus 919 that is also connected to memory 921 and input/output (I/O) components 923, as well as clock 925 and location system 927.

I/O components 923, in one embodiment, are provided to facilitate input and output operations and the device 916 can include input components such as buttons, touch sensors, optical sensors, microphones, touch screens, proximity sensors, accelerometers, orientation sensors and output components such as a display device, a speaker, and or a printer port. Other I/O components 923 can be used as well.

Clock 925 illustratively comprises a real time clock component that outputs a time and date. It can also provide timing functions for processor 917.

Illustratively, location system 927 includes a component that outputs a current geographical location of device 916. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 921 stores operating system 929, network settings 931, applications 933, application configuration settings 935, data store 937, communication drivers 939, and communication configuration settings 941. Memory 921 can include all types of tangible volatile and non-volatile computer-readable memory devices. It can also include computer storage media (described below). Memory 921 stores computer readable instructions that, when executed by processor 917, cause the processor to perform computer-implemented steps or functions according to the instructions. Processor 917 can be activated by other components to facilitate their functionality as well. It is expressly contemplated that, while a physical memory store 921 is illustrated as part of a device, that cloud computing options, where some data and/or processing is done using a remote service, are available.

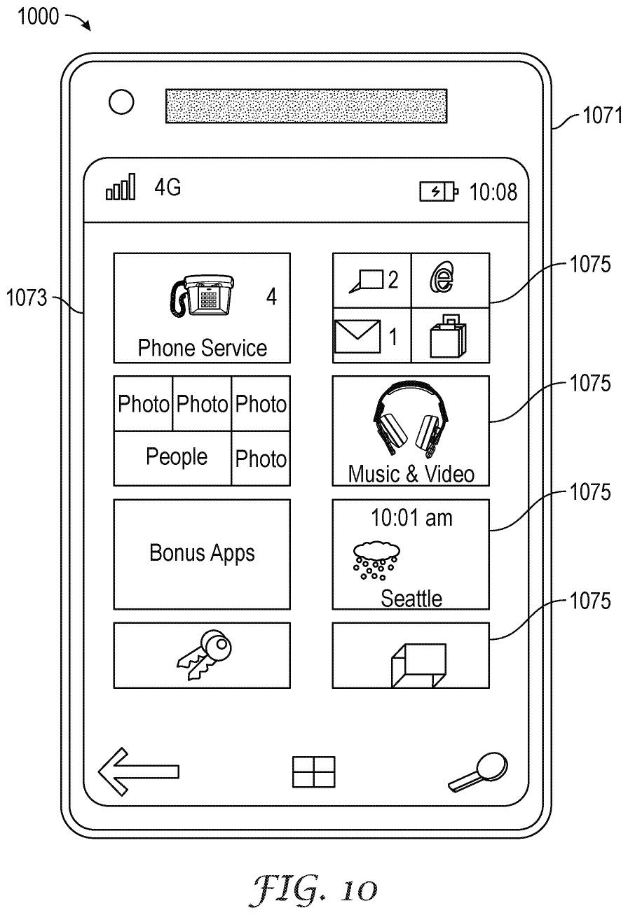

FIG. 10 shows that the device can also be a smart phone 1071. Smart phone 1071 has a touch sensitive display 1073 that displays icons or tiles or other user input mechanisms 1075. Mechanisms 1075 can be used by a user to run applications, make calls, perform data transfer operations, etc. In general, smart phone 1071 is built on a mobile operating system and offers more advanced computing capability and connectivity than a feature phone. Note that other forms of the devices are possible.

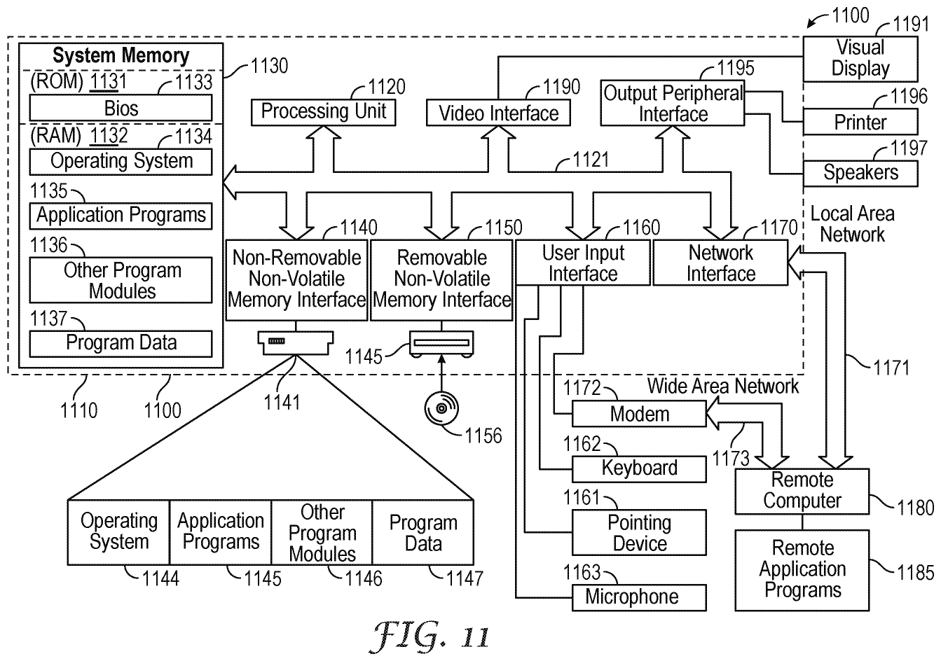

FIG. 11 is one example of a computing environment in which elements of systems and methods described herein, or parts of them (for example), can be deployed. With reference to FIG. 11, an example system for implementing some embodiments includes a general-purpose computing device in the form of a computer 1110. Components of computer 1110 may include, but are not limited to, a processing unit 1120 (which can comprise a processor), a system memory 1130, and a system bus 1121 that couples various system components including the system memory to the processing unit 1120. The system bus 1121 may be any of several types of bus structures including a memory bus or memory controller, a peripheral bus, and a local bus using any of a variety of bus architectures. Memory and programs described with respect to systems and methods described herein can be deployed in corresponding portions of FIG. 11.

Computer 1110 typically includes a variety of computer readable media. Computer readable media can be any available media that can be accessed by computer 1110 and includes both volatile/nonvolatile media and removable/non-removable media. By way of example, and not limitation, computer readable media may comprise computer storage media and communication media. Computer storage media is different from, and does not include, a modulated data signal or carrier wave. It includes hardware storage media including both volatile/nonvolatile and removable/non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 1110. Communication media may embody computer readable instructions, data structures, program modules or other data in a transport mechanism and includes any information delivery media. The term “modulated data signal” means a signal that has one or more of its characteristics set or changed in such a manner as to encode information in the signal.

The system memory 1130 includes computer storage media in the form of volatile and/or nonvolatile memory such as read only memory (ROM) 1131 and random-access memory (RAM) 1132. A basic input/output system 1133 (BIOS) containing the basic routines that help to transfer information between elements within computer 1110, such as during start-up, is typically stored in ROM 1131. RAM 1132 typically contains data and/or program modules that are immediately accessible to and/or presently being operated on by processing unit 1120. By way of example, and not limitation, FIG. 10 illustrates operating system 1134, application programs 1135, other program modules 1136, and program data 1137.

The computer 1110 may also include other removable/non-removable and volatile/nonvolatile computer storage media. By way of example only, FIG. 11 illustrates a hard disk drive 1141 that reads from or writes to non-removable, nonvolatile magnetic media, nonvolatile magnetic disk 1152, an optical disk drive 1155, and nonvolatile optical disk 1156. The hard disk drive 1141 is typically connected to the system bus 1121 through a non-removable memory interface such as interface 1140, and optical disk drive 1155 are typically connected to the system bus 1121 by a removable memory interface, such as interface 1150.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), etc.

The drives and their associated computer storage media discussed above and illustrated in FIG. 11, provide storage of computer readable instructions, data structures, program modules and other data for the computer 1110. In FIG. 11, for example, hard disk drive 1141 is illustrated as storing operating system 1144, application programs 1145, other program modules 1146, and program data 1147. Note that these components can either be the same as or different from operating system 1134, application programs 1135, other program modules 1136, and program data 1137.

A user may enter commands and information into the computer 1110 through input devices such as a keyboard 1162, a microphone 1163, and a pointing device 1161, such as a mouse, trackball or touch pad. Other input devices (not shown) may include a joystick, game pad, satellite receiver, scanner, a gesture recognition device, or the like. These and other input devices are often connected to the processing unit 1120 through a user input interface 1160 that is coupled to the system bus but may be connected by other interface and bus structures. A visual display 1191 or other type of display device is also connected to the system bus 1121 via an interface, such as a video interface 1190. In addition to the monitor, computers may also include other peripheral output devices such as speakers 1197 and printer 1196, which may be connected through an output peripheral interface 1195.

The computer 1110 is operated in a networked environment using logical connections, such as a Local Area Network (LAN) or Wide Area Network (WAN) to one or more remote computers, such as a remote computer 1180. The computer may also connect to the network through another wired connection. A wireless network, such as WiFi may also be used.

When used in a LAN networking environment, the computer 1110 is connected to the LAN 871 through a network interface or adapter 1170. When used in a WAN networking environment, the computer 1110 typically includes a modem 1172 or other means for establishing communications over the WAN 1173, such as the Internet. In a networked environment, program modules may be stored in a remote memory storage device. FIG. 11 illustrates, for example, that remote application programs 1185 can reside on remote computer 1180.

In the present detailed description of the preferred embodiments, reference is made to the accompanying drawings, which illustrate specific embodiments in which the invention may be practiced. The illustrated embodiments are not intended to be exhaustive of all embodiments according to the invention. It is to be understood that other embodiments may be utilized and structural or logical changes may be made without departing from the scope of the present invention. The following detailed description, therefore, is not to be taken in a limiting sense, and the scope of the present invention is defined by the appended claims.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

If implemented in software, the techniques may be realized at least in part by a computer-readable medium comprising instructions that, when executed in a processor, performs one or more of the methods described above. The computer-readable medium may comprise a tangible computer-readable storage medium and may form part of a computer program product, which may include packaging materials. The computer-readable storage medium may comprise random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The computer-readable storage medium may also comprise a non-volatile storage device, such as a hard-disk, magnetic tape, a compact disk (CD), digital versatile disk (DVD), Blu-ray disk, holographic data storage media, or other non-volatile storage device.

The term “processor,” as used herein may refer to any of the foregoing structure or any other structure suitable for implementation of the techniques described herein. In addition, in some respects, the functionality described herein may be provided within dedicated software modules or hardware modules configured for performing the techniques of this disclosure. Even if implemented in software, the techniques may use hardware such as a processor to execute the software, and a memory to store the software. In any such cases, the computers described herein may define a specific machine that is capable of executing the specific functions described herein. Also, the techniques could be fully implemented in one or more circuits or logic elements, which could also be considered a processor.

Here, the exemplary embodiments of the present invention have been described in detail, but it should be understood that the present invention is not limited to the specific embodiments described and illustrated in detail above. Those skilled in the art can make various variations and variants of the present invention without departing from the gist and scope of the present invention. All these variations and variants fall within the scope of the present invention. Moreover, all components described here can be replaced by other technically equivalent components.

A fit detection system for a respiratory protection device is presented. The system includes a camera that captures an image sequence of a user wearing the respiratory protection device. The system also includes a feature extractor that analyzes the image sequence and extracts features from the image sequence. The system also includes a fit score calculator that analyzes the extracted features and calculates a fit score indicative of how well the respiratory protection device fits the user. The system also includes a communication component that communicates the fit score.

The system may be implemented such that the camera automatically captures the image sequence upon detecting the user in a field of view of the camera.

The system may be implemented such that the camera is part of a stationary system.

The system may be implemented such that the camera is part of a mobile system.

The system may be implemented such that the feature extractor detects a designed feature.

The system may be implemented such that the feature extractor detects a learned feature.

The system may be implemented such that the feature extractor is an unsupervised system.

The system may be implemented such that the feature extractor detects a movement of the respiratory protection device in the image sequence.

The system may be implemented such that the feature extractor amplifies the detected movement.

The system may be implemented such that amplifying the detected movement includes using a Eulerian method, a Lagrangian method, a dense motion trajectory extraction, an optical flow method, a 3D ConvNet feature extraction, or multiple-stream 3D ConvNet feature extraction.

The system may be implemented such that the feature extractor reduces a second detected movement different from the detected movement.

The system may be implemented such that the feature extractor amplifies a detected expansion or contraction of the respiratory protection device. The feature extractor reduces a movement associated with the user.

The system may be implemented such that the feature extractor detects a color change in a pixel corresponding to the respiratory protection device.

The system may be implemented such that the feature extractor amplifies the color change.

The system may be implemented such that amplifying includes using a Eulerian method, a Lagrangian method, a dense motion trajectory extraction, an optical flow method, a 3D ConvNet feature extraction, or multiple-stream 3D ConvNet feature extraction.

The system may be implemented such that the image capture is triggered by a touch-free command.

The system may be implemented such that the touch-free command is an audio command from the user.

The system may be implemented such that the communication component communicates an alert if the fit score is below a fit threshold.

The system may be implemented such that the alert includes instructions for increasing a fit of the respiratory protection device.

The system may be implemented such that the camera captures a visual light spectrum, a full light spectrum, an infrared spectrum, or a near-infrared spectrum.

The system may be implemented such that the communication component communicates the fit score to a graphical user interface generator. The graphical user interface generator generates a graphical user interface that displays a fit indication.

The system may be implemented such that the fit indication includes a pass or fail indication, a quantitative fit score, an indication of a leak source, an instruction for improving the fit of the respiratory protection device.

A method for checking a fit of a respiratory protection device is presented that includes detecting an individual wearing the respiratory protection device. The method also includes capturing a sequence of images, using a camera, of the individual. The method also includes automatically extracting features from the images, using a feature extractor. The features are indicative of the fit of the respiratory protection device. The method also includes automatically analyzing the extracted features and, based on the analysis, quantitatively calculating a numerical fit value. The method also includes communicating a fit indication based on the numerical fit value.

The method may be implemented such that the fit indication is a pass indication or a fail indication.

The method may be implemented such that communicating includes outputting the fit indication as audio, visual or haptic feedback.

The method may be implemented such that the camera captures the sequence of images in a visual spectrum, an infrared spectrum, a near infrared spectrum or a full spectrum.

The method may be implemented such that detecting includes the camera detecting the individual in a field of view of the camera.

The method may be implemented such that detecting includes a user activating an application on a computing device.

The method may be implemented such that the computing device includes the camera.

The method may be implemented such that the camera is separate from the computing device.

The method may be implemented such that the feature extractor uses a supervised approach.

The method may be implemented such that the feature extractor extracts designed features.

The method may be implemented such that the feature extractor extracts learned features.

The method may be implemented such that the feature extractor uses an unsupervised approach.

The method may be implemented such that communicating includes providing an alert that the numerical fit value is below a fit threshold.

The method may be implemented such that communicating includes providing instructions for improving the numerical fit value.

The method may be implemented such that the steps of detecting, capturing, analyzing and communicating are completed without the individual touching a device.

The method may be implemented such that capturing a sequence of images includes activating a light source.

A touch free safety monitoring system is presented that includes a camera with a field of view configured to, when an individual is detected within the field of view, capture a sequence of images of a face of the individual. The system also includes a feature extractor that automatically extracts a feature within the sequence of images. The feature is associated with a respiratory protection device on the face of the individual. The system also includes a fit analyzer that, based on the extracted feature, automatically evaluates a fit of the respiratory protection device. The system also includes a communication module that communicates the evaluated fit.

The system may be implemented such that the system is mounted to a mobile station configured to move about an environment.

The system may be implemented such that the mobile station automatically moves about the environment according to a movement pattern.

The system may be implemented such that the system is incorporated into a device including the camera.

The system may be implemented such that the camera is a stationary camera within an environment.

The system may be implemented such that the communication module communicates the evaluated fit to an access point.

The system may be implemented such that the communication module provides the evaluated fit to a fit log for the individual.

The system may be implemented such that the evaluated fit is a numerical fit score.

The system may be implemented such that the communication module communicates a passing fit indication if the numerical fit score is above a fit threshold, and a failing fit indication if the numerical fit score is below the fit threshold.

The system may be implemented such that the communication module communicates an alert based on the evaluated fit.

The system may be implemented such that the communication module communicates instructions for improving the evaluated fit.

### EXAMPLES

### Example 1: Fit Evaluation

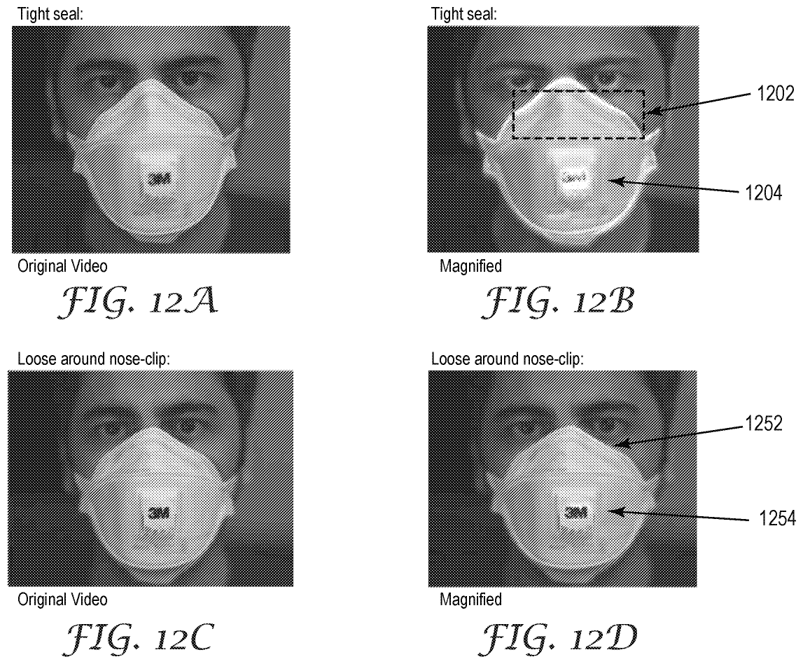

FIG. 12A illustrates an image obtained from an RGB (color) camera similar to what is seen by the human eye of a well-fitted respirator with a tight seal.

A computer vision-based algorithm extracts motion and color features, highlighting the brighter regions on the respirator to show that in a sealed respirator, there is more air-pressure on the surface of the respirator creating more small motions and color changes. In contrast, there are little changes when the respirator is not fit properly.

FIG. 12B illustrates a frame from the motion-amplified version of the same video. Box 1202 shows the area where small motions were amplified, visible as the brighter white rim of the respirator. The brighter white indicates where small motions occurred in the original video. The bright white area 1204 around the 3M logo on the valve cover also shows that small motions there were amplified.

FIG. 12C illustrates a poorly fitted respirator as seen by regular RGB camera or human naked eyes. In FIG. 12D, it would be expected that a well-fitted respirator would vibrate in the same fashion as the example above, but in the same locations, 1252, 1254 around the nose clip and on the valve cover with the 3M logo the same amplified motion is not seen. This means the air escaped in a different pattern than in the proper seal. This lack of motion indicates a poor seal.

Amplifying motion may be done using the Lagrangian method, which includes removing the camera motion. Feature points are tracked in the entire video, and trajectories of those feature points are clustered throughout the video. Some trajectories are not identical, but are still highly correlated.

Each pixel in each frame of the video is assigned to one of those clustered trajectories, including a “no trajectory” group of background-the assignation is based on motion, color and position. These trajectories are clustered into layers. The number of layers are limited.

The motion of every pixel in layers that are not the background layer is exacerbated by multiplying its trajectory, if that trajectory is reliable over the video. If this leaves gaps in the image where there is no pixel, the background is filled in with texture mapping, smoothing trajectories where needed.

Another way to amplify the motion, the Eulerian method, which is used to produce FIGS. 12B and 12D, and which works better for smaller motions and color changes, is described in Eulerian Video Magnification for Revealing Subtle Changes in the World, Wu et al., MIT CSAIL. In the Euler method, a range of temporal frequencies is selected to amplify. For example, to pick up a heartrate around 50-60 bpm, the 0.83-1 Hz frequency is chosen. An amplification factor (e.g. 4, or 40) is selected, as well as a spatial frequency cutoff, after which the amplification factor is attenuated or cut off. The method of cutoff is selected, e.g. force amplification to 0, or linearly scale down to zero. For each frame in a video, for each pixel, the pixel intensity is amplified if the intensity change occurs in the selected temporal frequency range from the first step. That intensity change is added back to the original pixel.

### Example 2

When a person wearing a respirator executes a specific motion such as scratching the nose, the seal of the respirator to the face may be compromised resulting in poor fit of the respirator. The system of this invention detects this adverse event and provides notification to the user to adjust the respirator as well as feedback to the user to avoid the specific action that led to the poor fit in the future.

Similarly, it may also be possible pick up wearer distress using this method. If an RPD filter media is overloaded, or a wearer is overheating, they start breathing faster and the motion of the respirator becomes faster, and it may be possible to pick up the new frequency and correlate that to user physiological changes.

1. A fit detection system for a respiratory protection device, the system comprising:
a camera that captures an image sequence of a user wearing the respiratory protection device;
a feature extractor that analyzes the image sequence and extracts features from the image sequence;
a fit score calculator that analyzes the extracted features and calculates a fit score indicative of how well the respiratory protection device fits the user; and
a communication component that communicates the fit score.

2. The system of claim 1, wherein the camera automatically captures the image sequence upon detecting the user in a field of view of the camera.

3. (canceled)

4. (canceled)

5. The system of claim 1, wherein the feature extractor is an unsupervised system.

6. The system of claim 1, wherein the feature extractor detects a movement of the respiratory protection device in the image sequence.

7. The system of claim 6, wherein the feature extractor amplifies the detected movement.

8. (canceled)

9. (canceled)

10. The system of claim 6, wherein the feature extractor amplifies a detected expansion or contraction of the respiratory protection device, and wherein the feature extractor reduces a movement associated with the user.

11. The system of claim 1, wherein the feature extractor detects a color change in a pixel corresponding to the respiratory protection device.

12. (canceled)

13. (canceled)

14. The system of claim 1, wherein the image capture is triggered by a touch-free command.

15. (canceled)

16. The system of claim 1, wherein the camera captures a visual light spectrum, a full light spectrum, an infrared spectrum, or a near-infrared spectrum.

17. The system of claim 1, wherein the communication component communicates the fit score to a graphical user interface generator, and wherein the graphical user interface generator generates a graphical user interface that displays a fit indication indicative of the fit score.

18. (canceled)

19. A method for checking a fit of a respiratory protection device, the method comprising:
detecting an individual wearing the respiratory protection device;
capturing a sequence of images, using a camera, of the individual;
automatically extracting features from the images, using a feature extractor, wherein the features are indicative of the fit of the respiratory protection device;
automatically analyzing the extracted features and, based on the analysis, quantitatively calculating a numerical fit value; and
communicating a fit indication based on the numerical fit value.

20. The method of claim 19, wherein the fit indication is a pass indication or a fail indication and wherein communicating comprises outputting the fit indication as audio visual of haptic feedback.

21. (canceled)

22. (canceled)

23. The method of claim 19, wherein detecting comprises the camera detecting the individual in a field of view of the camera.

24-26. (canceled)

27. The method of claim 26, wherein the feature extractor uses a supervised approach.

28. The method of claim 19, wherein the feature extractor uses an unsupervised approach.

29. The method of claim 19, wherein communicating comprises providing an alert that the numerical fit value is below a fit threshold.

30. (canceled)

31. The method of claim 19, wherein the steps of detecting, capturing, analyzing and communicating are completed without the individual touching a device.

32. (canceled)

33. A touch free safety monitoring system comprising:
a camera with a field of view configured to, when an individual is detected within the field of view, capture a sequence of images of a face of the individual;
a feature extractor that automatically extracts a feature within the sequence of images, wherein the feature is associated with a respiratory protection device on the face of the individual;
a fit analyzer that, based on the extracted feature, automatically evaluates a fit of the respiratory protection device; and
a communication module that communicates the evaluated fit.

34-37. (canceled)

38. The system of claim 33, wherein the communication module provides the evaluated fit to a fit log for the individual.

39. The system of claim 33, wherein the communication module communicates a passing fit indication if the numerical fit score is above a fit threshold, and a failing fit indication if the numerical fit score is below the fit threshold.

40. (canceled)
